(19) United States
(12) Patent Application Publication
(10) Pub. No.: US 2002/0120467 A1
(43) Pub. Date: Aug. 29, 2002

(54) Data processing system and method for managing the use of a medical device

(76) Inventor: Asbjorn Buanes, Oslo (NO)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/907,553

(22) Filed: Jul. 16, 2001

Related U.S. Application Data
(60) Provisional application No. 60/218,320, filed on Jul. 14, 2000.

(51) Int. Cl. G06F 17/60

(52) U.S. Cl. 705/2

(57) ABSTRACT

A data processing system and method for managing the use of a medical device such that a user is charged by a vendor at a predetermined rate for the use of the device. The system may comprise a computer memory, a loader/authenticater, a communications interface, a debitor/validator, a medical device configured for its functionability to be dependant on proper authorization by the debitor/validator, a controller, a user interface, and an accounting module.

### CROSS-REFERENCE TO RELATED APPLICATIONS

This application claims the benefit of U.S. Provisional Patent Application No. 60/218320, filed on Jul. 14, 2000, under § 119 (e).

### BACKGROUND OF THE INVENTION

1. Field of the Invention

This invention relates to the field of medical apparatuses. More specifically, the invention relates to a vendor controlled medical apparatus and data processing system for managing the use of a medical device such that a user is charged by a vendor at a predetermined rate for the use of the device.

2. Description of the Related Art

Several pay-per-use systems are known. For example, JP 11,259,574 discloses a license management procedure for game software, digital multimedia applications etc., involving the generation of data of pay per use, containing time loan and account data of digital contents, and monitoring to license management center for implementation.

U.S. Pat. No. 6,035,025 discloses a telecommunications prepaid service bundling method used in telecommunications networks

Such pay-per-use systems are, however, not known in medical applications. Capital intensive investments may be avoided if medical devices are able to maintain usage state, thus enabling the user (e.g. a hospital) to pay for the use of the device, rather than for the device itself. A such “fool-proof” way of paying for the actual usage of the equipment has not to this day existed.

As medical devices can be very costly, just paying for their use instead of the device itself can be a benefit to hospitals. Such approach requires that the device vendor keeps track of device usage for billing purposes, and also makes sure the device is inoperable if the bills are not paid. Also, the vendor has to be sure that unauthorized sale of device usage is impossible.

It is therefore a long felt need for a system and method for payment for use, and control of such use and of medical devices.

### BRIEF SUMMARY OF CERTAIN INVENTIVE ASPECTS

These and other objects and features of the invention are provided by aspects of the invention. In embodiments of the present invention, sale of usage permissions is done through any electronic channel. Security is maintained through encryption of the purchase data before transmission. The end user places the order directly. Also, the transmission data contains information about what device (serial number or other fingerprint) and also its usage, so that any number of copies of the transmitted data may exist, and still the transmitted data can only be used exactly once, on the device it was ordered for. As an option, the internal state of the device is transmitted (e.g. by way of a floppy disk) to the point-of-sale server in order to generate new permission data. One aspect of the invention includes a system comprising a computer memory means for receiving authenticated data from said vendor through a communications means and a loading/authenticating means, storing data, and releasing data to permit said user to use the medical device; a loader/authenticator means for receiving encrypted data, validating and reformatting of same, and transmitting data to said memory means; a communications interface means for transmitting encrypted data containing user- and device specific information, from a vendor to said loader/authenticator means; a debitor/validator means for validating the use of said medical device and for debiting said user's account in said memory means; a medical device, configured for its functionability to be dependant on proper authorization by said debitor/validator means; a controller means for processing and controlling data and control signals in said system; a user interface means for providing information between said users and said controller means; and an accounting means for recording the duration and the number of times said medical device is being used.

Another aspect of the invention includes a medical apparatus which comprises a computer memory; a loader/authenticator; a communications interface; a debitor/validator means; a medical device such as a flowmeter; a controller; a user interface; and an accounting means.

### BRIEF DESCRIPTION OF THE DRAWINGS

FIG. 1 is a data flow diagram, identifying the system modules, controls signals and data flow.

FIG. 2 indicates the communication between the ordering client and the point-of-sale.

FIG. 3 illustrates the process of ordering usage permissions.

FIG. 4 illustrates principles for using the device for medical purposes

### DETAILED DESCRIPTION OF CERTAIN EMBODIMENTS OF THE INVENTION

For the purposes of this application, a “patient procedure” is the use of the apparatus on a patient or subject. This period may be limited in time by a maximum duration and further use would then constitute a new patient procedure.

For the purposes of this application, an “electronic channel” is equipment or a medium capable of transmitting electronic data between two or more electronic devices. The devices do not have to be connected to the medium simultaneously, thus electronic channels also include floppy disks, cartridge drives (zip, syquest, etc.), smart cards, flash cards and tapes, as well as phone/modem connections, radio links and computer networks.

Through a process on the medical device, background data are generated. These data are encrypted and transmitted through any electronic channel to a point-of-sale server, where the order is processed. A block of encrypted data is then transmitted back to the medical device, which updates the internal state of the device to reflect the order. The transfer requires neither a real-time nor a secure link.

Each time the device is used, the internal state is changed to reflect the use. The state may be a number of uses, elapsed time or a combination of both, for example.

In this specific case, the electronic channel is a combination of a floppy disk and a networked computer, where the networked computer runs a client program for transferring the purchase data from the floppy disk to the point-of-sale server.

Although the present invention is disclosed as having the data block uniquely associated with the device for which it is intended, this feature is not strictly necessary. One embodiment of the present invention comprises device-independent data blocks; i.e. a given data block may contain appropriate authorizations for, e.g., type of procedure, durations, etc., but no authorizations related to the device itself.

In one embodiment, the method in accordance with the invention may include:

1. Obtain status information of a medical device (e.g., Butterfly Flowmeter).

2. A customer computer submits request for usage of the medical device.

3. An ordering computer 10 converts usage request to usage permissions.

4. Usage permissions are received by the medical device; and

5. If usage is allowed, then use the medical device and bill the customer, otherwise deny usage.

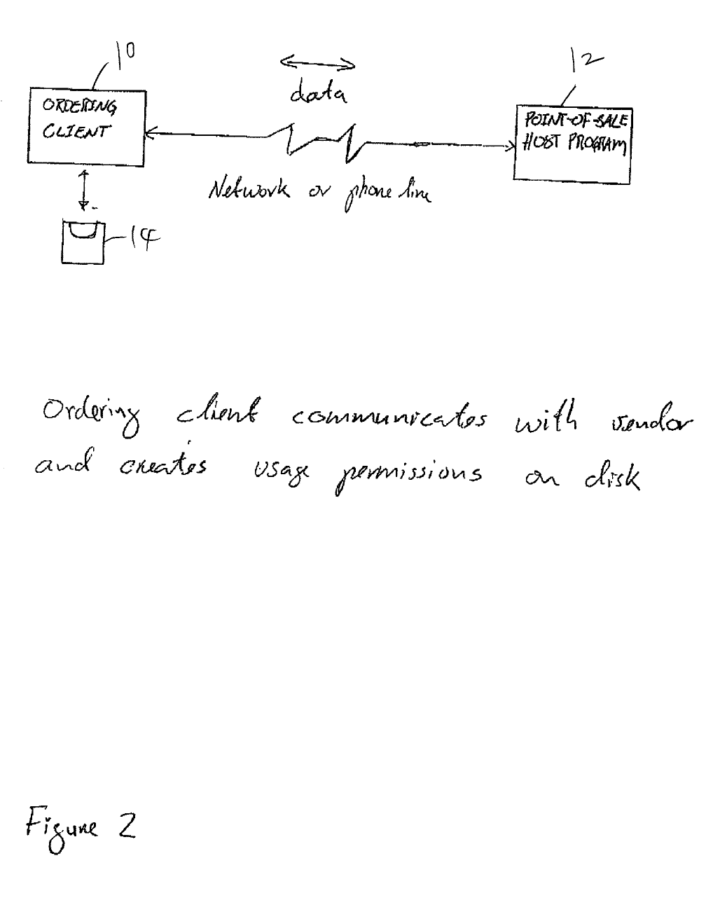

Referring to FIG. 2, an ordering client 10 communicates with a point-of sale host program 12 at the vendor site, and creates usage permissions on a disk 14. Data comprises an encrypted data related to the use of the device.

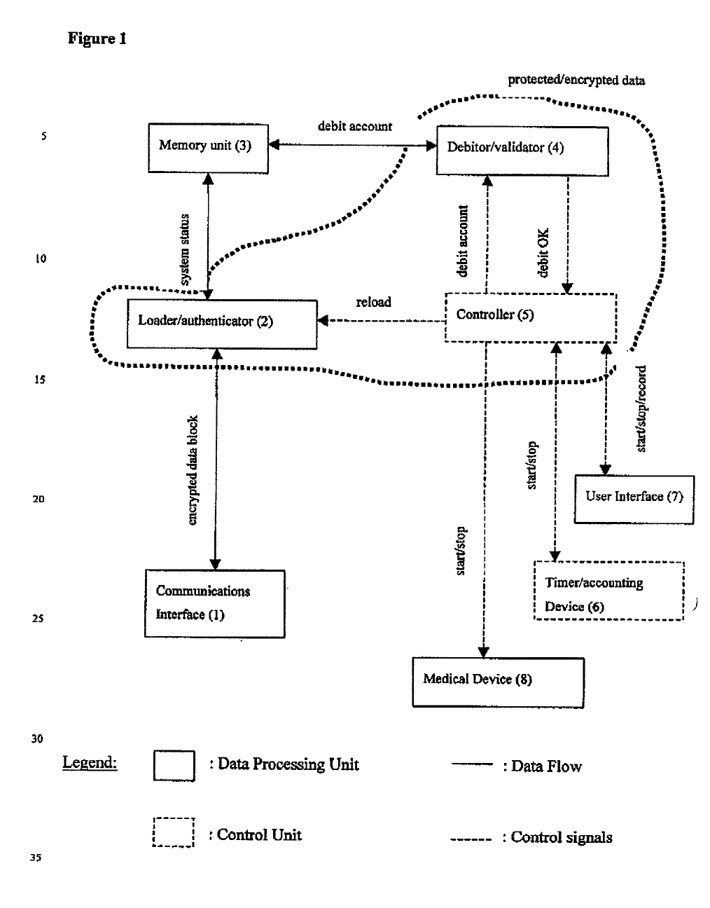

In a more detailed description and with reference to FIG. 1, one embodiment of the method according to the invention may include:

i) User requests a loading or reloading of (i.e., authorization to use) a medical device 8 through a user interface 7.

ii) The user interface 7 transmits the request to a controller 5.

iii) The Controller 5 transmits the request to loader/authenticator module 2.

iv) Receipt of the request in the loader/authenticator module 2, activates the communications interface 1 which will receive an encrypted data block from the vendor, e.g., in the form of a diskette. The encrypted data contains information regarding the medical device, and agreed particulars, etc., such as procedure duration.

v) The loader/authenticator module 2 authenticates the data block, e.g., checking expected format and valid data.

vi) If all checks are satisfactory, then the data block is transmitted to update a memory 3 which includes a non-volatile memory 3. The user starts the medical device 8 by sending an appropriate signal to the controller 5 via the user interface 7.

vii) The controller 5 starts a debitor/validator 4.

viii) The debitor/validator 4 sends a query to the non-volatile memory 3 for status of a user's account.

ix) If the account contains sufficient “funds” for the requested operation, the account is debited for the operation and the user is authorized through the controller 5 and the user interface 7 to proceed with the requested operation. If the account is insufficient, the user is notified accordingly and the requested operation is denied.

x) Upon receipt of the authorization from the debitor/validator 4, the controller 5 starts the timing/counting device 6 and enables the medical device 8 for use.

xi) If the medical device 8 is not turned off within the predetermined time (or number of steps, etc.), the controller 5 is notified by the timer, signalling the end of the procedure.

xii) The controller 5 will communicate this to the user and either shut down the system, start a new procedure or order the user interface 7 to prompt the user to make a decision as to terminating, reloading , etc.

In one embodiment, the data processing system in accordance with the invention comprises:

a) Computer memory means 3 for receiving authenticated data from said vendor through a communications interface 1 (e.g. a diskette or compact disk) and a loading/authenticating means 2, storing data, and releasing data to permit said user to use the medical device 8;

b) loader/authenticator means 2 for receiving encrypted data, validating and reformatting of same, and transmitting data to said memory means 3;

c) communications interface 1 for transmitting encrypted data containing user- and device specific information, from a vendor to said loader/authenticator means 2;

d) debitor/validator 4 means for validating the use of said medical device 8 and for debiting said user's account in said memory means 3;

e) medical device 8, configured for its functionability to be dependant on proper authorization by said debitor/validator means 4;

f) controller means 5 for processing and controlling data and control signals in said system;

g) user interface means 7 for providing information between said users and said controller means 5; and

h) accounting means 6 for recording the duration and the number of times said medical device 8 is being used;

The medical apparatus comprises a computer memory means 3, a loader/authenticator means 2, a communications interface means 1, a debitor/validator 4 means, a medical device (such as a flow meter) 8, a controller means 5, a user interface means 7, and an accounting means 6.

The communications interface means 1 transmits encrypted data issued by the vendor, to said loader/authenticator 2.

The loader/authenticator means 2 is responsive to control signals from the controller means 5, activates the communications interface 1 on request, receives encrypted data from the communications interface 1, authenticates encrypted data and transmits data to said memory means 3.

The memory means 3 receives authenticated data from said loader/authenticator means 2, stores data, and releases data to-and as requested by-said debitor/validator 4.

The debitor/validator means 4, when activated by the said controller 5, sends a query to said memory means 3 for the status of the user's account, debits the account in said memory means 3 if sufficient funds are available and transmits the corresponding data to said controller 5.

The controller means 5 processes and manages data flow and control signals in said apparatus.

The medical device 8 is configured for its functionability to be dependent on proper authorization by said debitor/validator means 4.

The user interface 7 provides information between said users and said controller 5.

The accounting means 6 records the duration and the number of times said medical device 8 is being used.

xiii) The disk is in real applications often a typical medium, as the medical device most frequently is being used in operating rooms where local infrastructure for connection to public networks are rare. In addition, as the device is capable of storing patient data, communication via public networks could pose a security problem.

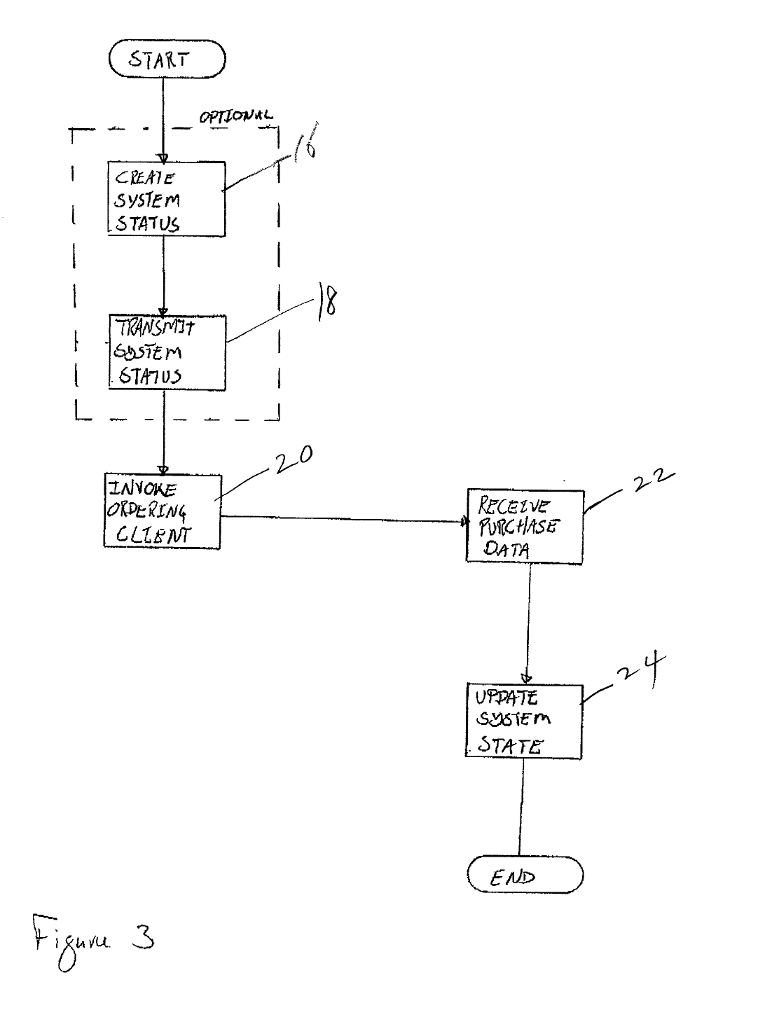

Referring to FIG. 3, ordering usage permissions will be explained. The ordering client 10 creates system status and transmits the system status to the point-of-sale host program 12 at the host site (states 16, 18). The states 16 and 18 may be optional. The ordering client 10 is invoked at state 20. The ordering client 10 transmits purchase data to the point-of-sale host program 12 at the host site, and the system state is updated with the purchase data (states 22, 24).

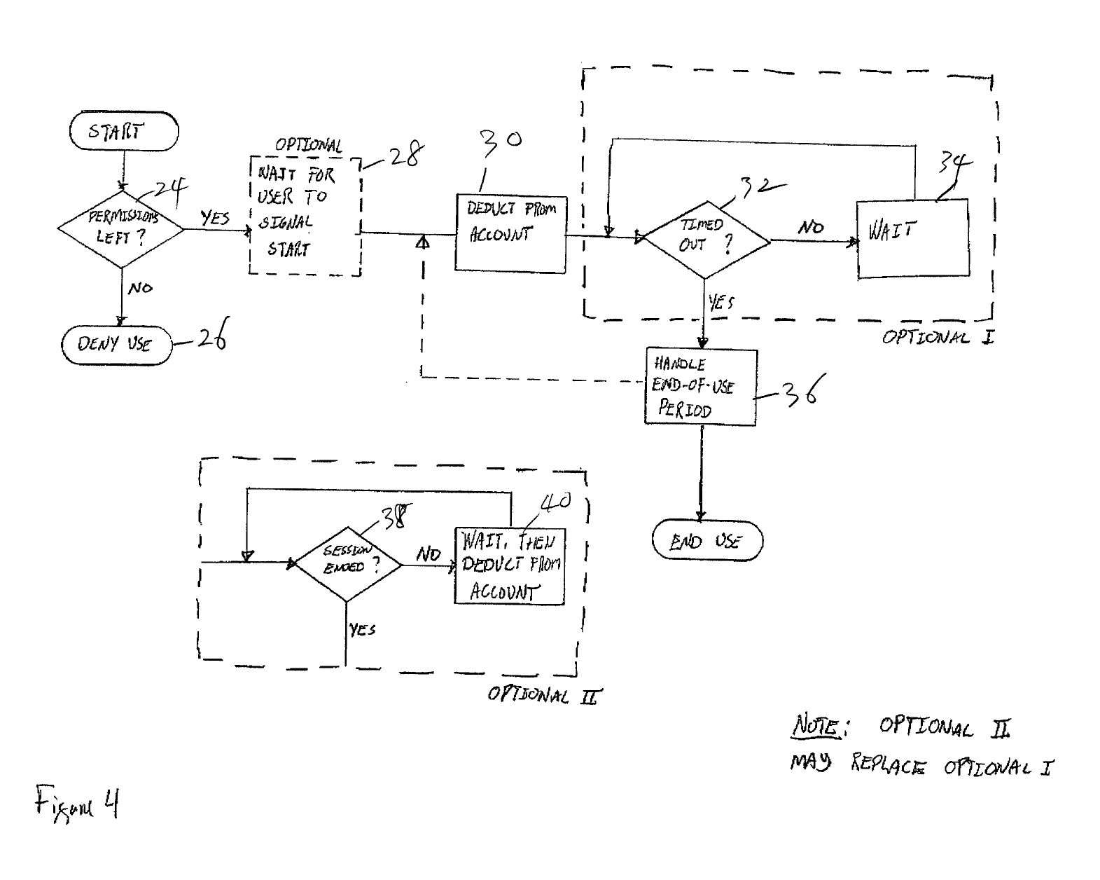

Referring to FIG. 4, principles for using the device for medical purposes will be explained. It is determined whether any permissions are left (state 24). If it is determined that permissions have not been left in the state 24, the use of the medical device 8 is denied (state 26). If it is determined that permissions are left in the state 24, the system waits until the user signals for start (state 28). The state 28 may be optional. Funds are deducted from the user's account in the memory unit 3 (state 30). It is determined whether time that has been permitted for using the medical device 8 is over (state 32). If it is determined that time is not over in the state 32, the system waits (state 34) and performs the state 32 again. If it is determined that time is over in the state 32, the system handles the end-of-use period (state 36). After the state 36 is performed, the use of the device is ended or, optionally, the state 30 is performed again. States 32 and 34 may be optional and may replace the following states 38 and 40 which may also be optional. It is determined whether the session is ended at state 38. If it is determined that the session is not ended, the system waits and then deducts funds from the user's account in the memory unit 3 (state 40), and performs the state 38 again. If it is determined that the session is ended, the state 36 is performed as noted above.

In daily use, the system is almost transparent compared to an ordinary flowmeter. The most notable difference is that the user has to press a “start” button, in order to initiate a new procedure which starts the measuring system. If the remaining number of authorized procedures is low or zero, appropriate warning messages are displayed after the apparatus is turned on, and after starting a new procedure.

Refilling the system is done by inserting a properly generated disk and pressing the “reload” button. This initiates the transfer of authorizations to the apparatus, and no further interaction is necessary to complete the transfer.

In order to reload the system, the operator or user orders the reload through the user interface 7. This signals to the controller 5 that a reload is under way, and sends the request on to the loader/authenticator module 2. This starts the communications interface 1, which will receive an encrypted block of data, containing information about what device it is ordered for, and the status the device should be in, from the vendor. The loader/authenticator 2 then authenticates the data block, checking it for expected format and valid data. If all checks are satisfactory, the non-volatile memory 3 is updated to reflect the new system status.

For operation, the operator or user orders the system to start measuring through a button on the user interface 7. The controller 5 is notified, and starts the debitor/validator 4. This module then probes the non-volatile memory 3 for system status, and verifies that there are procedures left and debits the account. If this is satisfactory, a notification is sent back to the controller 5 signaling that the procedure is authorized, otherwise an error is indicated and the user is prompted by the controller 5 to reload. Then, the debitor/validator 4 will debit the memory unit 3 (system status).

Upon receipt of the authorization, the controller 5 starts the timer 6, and also enables the medical device 8. If the apparatus is not turned off within the timed maximum duration of the procedure, the controller 5 is notified by the timer 6, signaling the end of the procedure. The controller 5 may then either shut down the system, initiate a new procedure, or order the user interface 7 to prompt the operator to confirm or decline the start of a new procedure.

With very small changes, the mechanism for controlling access to the medical device 8 can be adapted to use “electronic purse” smart cards or ordinary credit/debit cards with the attachment of the correct card reader.

The medical apparatus according to the invention may thus be used for a variety of vendor controlled services.

The foregoing description and the embodiments of the present invention are to be construed as mere illustrations of the application of the principles of the invention. The foregoing is not intended to limit the scope of the claims, but the true spirit and scope of present invention is defined by the claims.

What is claimed is:

1. A data processing system for managing the use of a medical device such that a user is charged by a vendor at a predetermined rate for the use of the device, said system comprising:
a) computer memory means for receiving authenticated data from said vendor through a communications means and a loading/authenticating means, storing data, and releasing data to permit said user to use the medical device;
b) loader/authenticator means for receiving encrypted data, validating and reformatting of same, and transmitting data to said memory means;
c) communications interface means for transmitting encrypted data from a vendor to said loader/authenticator means;
d) debitor/validator means for validating the use of said medical device and for debiting said user's account in said memory means;
e) medical device, configured for its functionability to be dependant on proper authorization by said debitor/validator means;
f) controller means for processing and controlling data and control signals in said system;
g) user interface means for providing information between said users and said controller means; and
h) accounting means for recording the duration and the number of times said medical device is being used.

2. A system in accordance with claim 1, wherein said encrypted data containers user-and device specific information.

3. A medical apparatus, comprising:
a) computer memory means;
b) loader/authenticator means;
c) communications interface means;
d) debitor/validator means;
e) medical device;
f) controller means;
g) user interface means; and
h) accounting means;
wherein:
said communications interface means transmits encrypted data issued by the vendor, to said loader/authenticator;
said loader/authenticator means is responsive to control signals from said controller means, activates the communications interface on request, receives encrypted data from the communications interface, authenticates encrypted data and transmits data to said memory means;
said memory means receives authenticated data from said loader/authenticator means, stores data, and releases data to-and as requested by-said debitor/validator;
said debitor/validator means, when activated by the said controller, sends a query to said memory means for the status of the user's account, debits the account in said memory means if sufficient funds are available and transmits the corresponding data to said controller;
said controller means processes and manages data flow and control signals in said apparatus;
said medical device is configured for its functionability to be dependant on proper authorization by said debitor/validator means;
said user interface means provides information between said users and said controller means; and
said accounting means records the duration and the number of times said medical device is being used.

4. The medical apparatus as defined in claim 2, where the medical device comprises a flowmeter.

5. A method for managing the use of a medical device such that a user is charged by a vendor at a predetermined rate for the use of the device, said method comprising:
a) user requesting a loading or reloading of medical device through user interface;
b) user interface transmitting the request to controller;
c) controller transmitting the request to loader/authenticator module;
d) receiving request in loader/authenticator module, and activating the communications interface for receipt of an encrypted data block from the vendor;
e) the loader/authenticator module authenticating the data block;
f) conditions allowing, transmitting the data block is to update the non-volatile memory;
g) user starting medical device by sending the appropriate signal to the controller via the user interface;
h) controller starting the debitor/validator;
i) debitor/validator sending query to non-volatile memory for status of user's account;
j) if the account containing sufficient “funds” for the requested operation, debiting account for the operation and authorising user through the controller and user interface to proceed with the requested operation;
k) if the account is insufficient, notifying user accordingly and the denying the requested operation;
l) on receipt of the authorization from the debitor/validator, the controller starting the timing/counting device and enables the medical device for use;
m) if the medical device is not turned off within the predetermined time (or number of steps, etc.), the timer notifying the controller signalling the end of the procedure;
n) controller communicating this to the user and either shutting down the system, starting a new procedure or order the user interface to prompt the user to make a decision as to terminating, reloading, etc.

6. The method in accordance with claim 5, wherein said data blocks are device-independent.

7. A data processing system for managing the use of a medical device such that a user is charged by a vendor at a predetermined rate for the use of the device, said system comprising:
a computer memory for receiving authenticated data from said vendor, storing data, and releasing data to permit said user to use the medical device;
a loader/authenticator for receiving encrypted data, validating and re-formatting of same, and transmitting data to said memory;
a communications interface for transmitting the encrypted data from said vendor to said loader/authenticator;
a debitor/validator for validating the use of said medical device and for debiting said user's account in said memory;
a controller for processing and controlling data and control signals in said system;
a user interface for providing information between said users and said controller; and
an accounter for recording the duration and the number of times said medical device is being used;
wherein the medical device is configured for its functionability to be dependent on proper authorization by said debitor/validator.

8. A medical apparatus, comprising:
a computer memory;
a loader/authenticator;
a communications interface;
a debitor/validator;
a medical device;
a controller;
a user interface; and
an accounter;
wherein said communications interface transmits encrypted data issued by the vendor, to said loader/authenticator,
said loader/authenticator is responsive to control signals from said controller, activates the communications interface on request, receives encrypted data from said communications interface, authenticates encrypted data and transmits data to said memory,
said memory receives authenticated data from said loader/authenticator, stores data, and releases data to-and as requested by-said debitor/validator,
said debitor/validator, when activated by the said controller, sends a query to said memory for the status of the user's account, debits the account in said memory, if sufficient funds are available and transmits the corresponding data to said controller,
said controller processes and manages data flow and control signals in said apparatus,
said medical device is configured for its functionability to be dependent on proper authorization by said debitor/validator,
said user interface provides information between said users and said controller and
said accounter records the duration and the number of times said medical device is being used.

9. A method for managing the use of a medical device such that a user is charged by a vendor at a predetermined rate for the use of the device, said method comprising:
the user requesting a loading or reloading of the medical device through a user interface;
the user interface transmitting the request to a controller;
the controller transmitting the request to a loader/authenticator module;
receiving request in the loader/authenticator module, and activating a communications interface for receipt of an encrypted data block from the vendor;
the loader/authenticator module authenticating the data block;
conditions allowing, transmitting the data block is to update a non-volatile memory;
the user starting the medical device by sending an appropriate signal to the controller via the user interface;
the controller starting a debitor/validator;
the debitor/validator sending query to the non-volatile memory for status of user's account;
if the account containing sufficient “funds” for the requested operation, debiting account for the operation and authorising user through the controller and user interface to proceed with the requested operation;
if the account is insufficient, notifying the user accordingly and denying the requested operation;
on receipt of the authorization from the debitor/validator, the controller starting a timing/counting device and enables the medical device for use;
if the medical device is not turned off within a predetermined time, the timing/counting device notifying the controller signalling the end of the procedure; and
the controller communicating this to the user and either shutting down the system, starting a new procedure or order the user interface to prompt the user to make a decision as to terminating, and reloading.

10. A data processing system for managing the use of a medical device such that a user is charged by a vendor at a predetermined rate for the use of the device, the system comprising:
a memory adapted to store authenticated data and fund status, and release the data to permit the user to use the device;
an authenticator adapted to receive encrypted data including information related to a use of the device from the vendor, authenticate the data, and transmit the authenticated data to the memory;
a debitor/validator adapted to validate the use of the device based on fund status of the user's account and the authenticated data, and debit the user's account in the memory; and
a controller adapted to enable the device for the use, based on the validation of the debitor/validator.

11. The data processing system in accordance with claim 10, further comprising a timer for adapted to record the duration and the number of times that the device is being used.

12. The data processing system in accordance with claim 10, further comprising a user interface adapted to interface between the user and the controller.

13. The data processing system in accordance with claim 10, further comprising a communications interface adapted to interface between the authenticator and the vendor.

14. The data processing system in accordance with claim 13, wherein the authenticator is responsive to a control signal from the controller, and activates the communications interface to receive the encrypted data from the vendor.

15. The data processing system in accordance with claim 10, wherein said controller starts said debitor/validator in responsive to the user's start of the device.

16. The data processing system in accordance with claim 10, wherein the timer notifies the controller the end of the use of the device, if the device is not turned off within a predetermined time.

17. The data processing system in accordance with claim 10, wherein the medical device comprises a flowmeter.

18. The data processing system in accordance with claim 10, wherein the information related to the use of the device comprises information related to the user and the device.

19. The data processing system in accordance with claim 10, wherein the information related to the use of the device comprises durations of a procedure, and a type of procedure, related to the use of the device.

20. A method of managing the use of a medical device such that a user is charged by a vendor at a predetermined rate for the use of the device, the method comprising:
receiving a request for a loading or reloading of the device from the user;
receiving an encrypted data including information related to the user and the device from the vendor;
authenticating the encrypted data;
storing the authenticated data and fund status;
validating the use of the device based on the stored fund status and the authenticated data; and
enabling the device for the use, based on the validation.

21. The method in accordance with claim 20, wherein the storing comprises storing the fund status in the user's account of a memory.

22. The method in accordance with claim 21, wherein the validating comprises validating the use of the device based on the stored status of the user's account .

23. The method in accordance with claim 22, further comprising debiting the user's account in the memory.

24. The method in accordance with claim 21, further comprising recording the duration and the number of times that the device is being used.

25. The method in accordance with claim 21, wherein the authenticating the encrypted data comprises checking a format of the data and validity of the data.

26. A computer-readable medium containing instructions for controlling a computer system to manage the use of a medical device such that a user is charged by a vendor at a predetermined rate for the use of the device, by:
receiving a request for a loading or reloading of the device from the user;
receiving an encrypted data including information related to the user and the device from the vendor;
authenticating the encrypted data;
storing the authenticated data and fund status;
validating the use of the device based on the stored fund status and the authenticated data; and
enabling the device for the use, based on the validation.

27. A program storage device readable by a machine, tangibly embodying a program of instructions executable by the machine to perform a method of managing the use of a medical device such that a user is charged by a vendor at a predetermined rate for the use of the device, the method comprising:
receiving a request for a loading or reloading of the device from the user;
receiving an encrypted data including information related to the user and the device from the vendor;
authenticating the encrypted data;
storing the authenticated data and fund status;
validating the use of the device based on the stored fund status and the authenticated data; and
enabling the device for the use, based on the validation.

28. A computer data signal embodied in a carrier wave and representing executable program instructions comprising instructions for:
receiving a request for a loading or reloading of the device from the user;
receiving an encrypted data including information related to the user and the device from the vendor;
authenticating the encrypted data;
storing the authenticated data and fund status;
validating the use of the device based on the stored fund status and the authenticated data; and
enabling the device for the use, based on the validation.
